(19) United States
(12) Patent Application Publication
(10) Pub. No.: US 2012/0105247 A1
(43) Pub. Date: May 3, 2012

(54) BLACKBOX POSITION REPORTING DEVICE

(76) Inventor: Yat Wai Edwin Kwong, Hong Kong (HK)

(21) Appl. No.: 12/938,880

(22) Filed: Nov. 3, 2010

(51) Int. Cl. H04B 13/02

(52) U.S. Cl. 340/850

(57) ABSTRACT

Systems and methods are provided for reporting activities at certain locations below sea level. One embodiment includes a flight recorder system for collecting and reporting activities at specific locations below sea level. Further, the system is configured to provide automatic, real-time, collection of aircraft data and then transmission of such data to a world-wide communication system for subsequent reception, analysis, storage and generation of aircraft flight, safety, and fuel efficiency.

### BACKGROUND

I. Technical Field

The present invention generally relates to systems and methods for reporting activities at certain locations below sea level. Specifically, and without limitation, the invention relates to flight recorder systems for collecting and reporting activities at specific locations below sea level. Further, this invention relates to the field of flight recorders and more particularly to automatic, real-time, collection of aircraft data and then transmission of such data to a world-wide communication system for subsequent reception, analysis, storage and generation of aircraft flight, safety, and fuel efficiency.

II. Background Information

Preventive measures in connection with accidents concerning aeroplanes safety are becoming increasingly popular. Whenever an airplane crashes, nearly all authorities work diligently to find the flight data recorder. The task becomes one of the top priorities for the government and enforcement officials because every party involved in the accident would like to seek out the causes of the accidents, so that future tragedies may hopefully be avoidable. Investigations may last for months or years. Sometimes, investigations may go on for months or even years for investigation purposes. Traces of accidents may come from the wreckages. Meanwhile, testimonies may come from survivors, if there are any. Questions may be answered from these surviving passengers, with respect to what went on when the accidents occurred. There are questions, however, that cannot be answered easily by witnesses. In those cases, flight data or crash recorders may provide a scientific means for purposes of facts finding. A flight data or crash recorder is sometimes also called a black box, and is usually a tape recorder which is capable of recording many channels of information, when flight accidents occur. The problem is, however, that during a plane crash, the blackbox may submerge into the sea. In such a case, the blackbox may not be found easily by the investigation officials. To facilitate searching of the blackbox, the blackbox or the tracking device must be easily located, so that the investigation officials can extract data from the blackbox at ease without causing much delay. Otherwise, the whole investigation may be take months or years for the rescue ships to locate such devices.

In view of the foregoing, there is a need for systems and methods that can report activities locations below sea level. There is also a need for systems and methods that can facilitate flight recorder systems to collect and report activities at specific locations below sea level.

### SUMMARY

Embodiments of the present invention relates to methods and systems for reporting locations below sea level using a global positioning system without using any sonar-related equipments. According to embodiments of the invention, a blackbox serving as a flight recorder may be provided. The blackbox includes recording information in connection with a plane crash. In addition, embodiments may include a global positioning system (GPS) for providing GPS data representing positions of GPS receivers. A housing that is attached to the blackbox may also be included, wherein the housing is made of material that offers high buoyancy. Further, a GPS receiver embedded in the housing may be provided, wherein the GPS receiver locates information in connection with positions above the sea level only. In addition, a transmitter embedded in the housing and is capable to transmit signals by air only. A processing unit included in the blackbox for combining the recording information and the information in connection with the positions located by the GPS receiver may also be provided. Embodiments may also include a physical communication link linking between the blackbox and the housing. The link maybe made of perfectly elastic material, and the link can be configured to allow the blackbox to be fully attached physically to the housing shortly after the plane crash when the blackbox sinks into a sea bottom, and the GPS receiver embedded in the housing fails to locate any GPS signals from the GPS System under the sea.

According to one embodiment, the physical communication link is configured to transfer information from the GPS receiver embedded in the housing to the processing unit included in the blackbox, wherein the information includes a location captured by the GPS receiver embedded in the housing when the housing buoys onto the water.

In another embodiment, the physical communication link is configured to transfer information from the processing unit included in the blackbox to the housing, wherein the information transferred includes a combination of the location captured by the GPS receiver and the information in connection with the plane crash included in the blackbox, and wherein the transferred information received by the housing uses the transmitter to broadcast the combined information as signals by air for rescue.

In yet another embodiment, the physical communication link can be configured to save power, re-attach and collapsing physically the housing and the blackbox after broadcasting the combined information for rescue, the housing re-sinking into the bottom of the sea and reattaching with the housing, and the GPS receiver embedded in the housing failing to locate any GPS signals from the GPS System under the sea.

In an alternate embodiment, the physical communication link may be configured to, after a pre-determined period expires, allow the GPS receiver embedded in the housing to buoy onto the water to locate another position, after the blackbox has moved to a new position below the sea.

Further, the physical communication link may alternatively be configured to allow the transmitter to broadcast the new position and the information in connection with the plane crash included in the blackbox as combined information.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating a flight recorder system, consistent with an embodiment of the invention.

### DETAILED DESCRIPTION

Embodiments of the present invention include a flight recorder system for reporting locations below sea level using an global positioning system without using any sonar-related equipments, where global positioning system signals do not propagate across water, said system comprises a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only.

Further, a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom, the GPS receiver embedded in the housing 110 failing to locate any GPS signals from the GPS System under the sea.

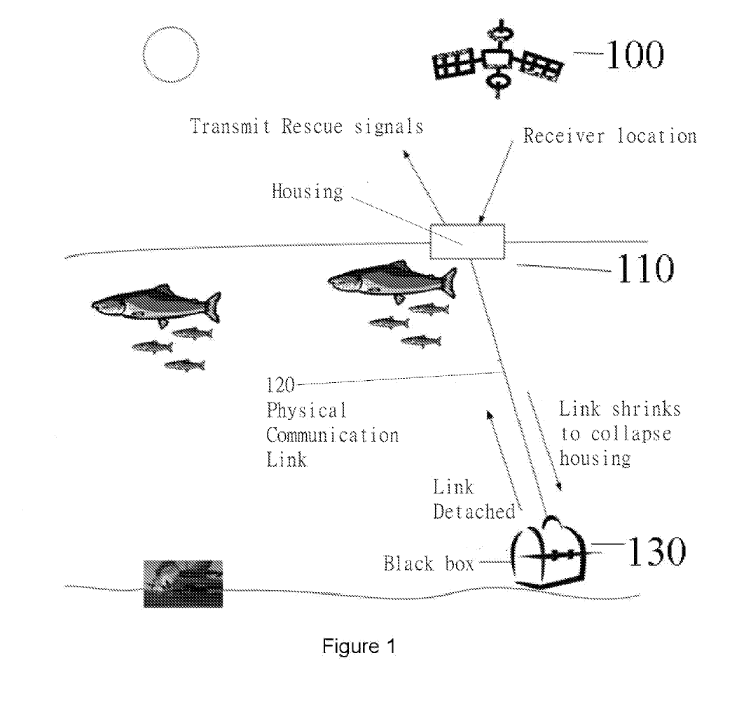

Referring to FIG. 1, a flight recorder system is provided. The system is configured to report locations below sea level using an global positioning system without using any sonar-related equipments, where global positioning system signals do not propagate across water, said system comprising a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110; wherein the GPS receiver locates information in connection with positions above the sea level only; a transmitter embedded in the housing 110 and is capable to transmit signals by air only.

A processing unit is included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom, the GPS receiver embedded in the housing 110 failing to locate any GPS signals from the GPS System under the sea; and allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom.

In one implementation, the flight recorder system comprises a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only; a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom.

The GPS receiver is embedded in the housing 110 failing to locate any GPS signals from the GPS System under the sea; allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom; and transfer information from the GPS receiver embedded in the housing 110 to the processing unit included in the black box 130, wherein the information includes a location captured by the GPS receiver embedded in the housing 110 when the housing 110 buoys onto the water.

In a different implementation, the flight recorder system comprises a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only; a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom.

The GPS receiver is embedded in the housing 110 failing to locate any GPS signals from the GPS System under the sea; allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom; transfer information from the GPS receiver embedded in the housing 110 to the processing unit included in the black box 130, wherein the information includes a location captured by the GPS receiver embedded in the housing 110 when the housing 110 buoys onto the water; and transfer information from the processing unit included in the black box 130 to the housing 110, wherein the information transferred includes a combination of the location captured by the GPS receiver and the information in connection with the plane crash included in the black box 130, and wherein the transferred information received by the housing 110 uses the transmitter to broadcast the combined information as signals by air for rescue.

In another implementation, a different flight recorder system is provided for reporting locations below sea level using an global positioning system without using any sonar-related equipments, where global positioning system signals do not propagate across water, said system comprising a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only; a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom.

The GPS receiver may be embedded in the housing 110 failing to locate any GPS signals from the GPS System under the sea; allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom; transfer information from the GPS receiver embedded in the housing 110 to the processing unit included in the black box 130, wherein the information includes a location captured by the GPS receiver embedded in the housing 110 when the housing 110 buoys onto the water; transfer information from the processing unit included in the black box 130 to the housing 110, wherein the information transferred includes a combination of the location captured by the GPS receiver and the information in connection with the plane crash included in the black box 130, and wherein the transferred information received by the housing 110 uses the transmitter to broadcast the combined information as signals by air for rescue; and to save power, re-attach and collapsing physically the housing 110 and the black box 130 after broadcasting the combined information for rescue, the housing 110 re-sinking into the bottom of the sea and reattaching with the housing 110, and the GPS receiver embedded in the housing 110 failing to locate any GPS signals from the GPS System under the sea.

In yet another implementation, the flight recorder system reports locations below sea level using an global positioning system without using any sonar-related equipments, where global positioning system signals do not propagate across water. The system comprises a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only; a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110, wherein the link 120 is made of perfectly elastic material, and the link 120 is configured to allow the black box 130 to be fully attached physically to the housing 110 shortly after the plane crash when the black box 130 sinks into a sea bottom, the GPS receiver embedded in the housing 110 failing to locate any GPS signals from the GPS System under the sea; allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom; transfer information from the GPS receiver embedded in the housing 110 to the processing unit included in the black box 130.

The information may include a location captured by the GPS receiver embedded in the housing 110 when the housing 110 buoys onto the water; transfer information from the processing unit included in the black box 130 to the housing 110, wherein the information transferred includes a combination of the location captured by the GPS receiver and the information in connection with the plane crash included in the black box 130, and wherein the transferred information received by the housing 110 uses the transmitter to broadcast the combined information as signals by air for rescue; to save power, re-attach and collapsing physically the housing 110 and the black box 130 after broadcasting the combined information for rescue, the housing 110 re-sinking into the bottom of the sea and reattaching with the housing 110, and the GPS receiver embedded in the housing 110 failing to locate any GPS signals from the GPS System under the sea; and after a pre-determined period expires, allow the GPS receiver embedded in the housing 110 to buoy onto the water to locate another position, after the black box 130 has moved to a new position below the sea.

According to another implementation, a flight recorder system for reporting locations below sea level using an global positioning system without using any sonar-related equipments, where global positioning system signals do not propagate across water, said system comprising a black box 130 serving as a flight recorder, wherein the black box 130 includes recording information in connection with a plane crash; a global positioning system (GPS) for providing GPS data representing positions of GPS receivers, a housing 110 that is attached to the black box 130, wherein the housing 110 is made of material that offers high buoyancy; a GPS receiver embedded in the housing 110, wherein the GPS receiver locates information in connection with positions above the sea level only; a transmitter embedded in the housing 110 and is capable to transmit signals by air only; a processing unit included in the black box 130 for combining the recording information and the information in connection with the positions located by the GPS receiver; a physical communication link 120 linking between the black box 130 and the housing 110.

The link 120 may be made of perfectly elastic material or inelastic material, and the link 120 is configured to allow the black box 130 to be fully attached physically to the housing 110 shortly after the plane crash when the black box 130 sinks into a sea bottom, the GPS receiver embedded in the housing 110 failing to locate any GPS signals from the GPS System under the sea; allow the housing 110 to be detached physically from the black box 130 after a period of time after sinking into the sea bottom when the black box 130 survives the plane crash, the housing 110, due to its buoyancy, floating onto the water, and the physical ink serving as the only physical media linking between the housing 110 floating onto the water and the black box 130 onto the sea bottom; transfer information from the GPS receiver embedded in the housing 110 to the processing unit included in the black box 130, wherein the information includes a location captured by the GPS receiver embedded in the housing 110 when the housing 110 buoys onto the water; transfer information from the processing unit included in the black box 130 to the housing 110, wherein the information transferred includes a combination of the location captured by the GPS receiver and the information in connection with the plane crash included in the black box 130, and wherein the transferred information received by the housing 110 uses the transmitter to broadcast the combined information as signals by air for rescue; to save power, re-attach and collapsing physically the housing 110 and the black box 130 after broadcasting the combined information for rescue, the housing 110 re-sinking into the bottom of the sea and reattaching with the housing 110, and the GPS receiver embedded in the housing 110 failing to locate any GPS signals from the GPS System under the sea; after a pre-determined period expires, allow the GPS receiver embedded in the housing 110 to buoy onto the water to locate another position, after the black box 130 has moved to a new position below the sea; and allow the transmitter to broadcast the new position and the information in connection with the plane crash included in the black box 130 as combined information.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A flight recorder system for reporting locations below sea level using an global positioning system without using any sonar-related equipments, where global positioning system signals do not propagate across water, said system comprising a blackbox serving as a flight recorder, wherein the blackbox includes recording information in connection with a plane crash;
a global positioning system (GPS) for providing GPS data representing positions of GPS receivers,
a housing that is attached to the blackbox, wherein the housing is made of material that offers high buoyancy;
a GPS receiver embedded in the housing, wherein the GPS receiver locates information in connection with positions above the sea level only;
a transmitter embedded in the housing and is capable to transmit signals by air only;
a processing unit included in the blackbox for combining the recording information and the information in connection with the positions located by the GPS receiver;
a physical communication link linking between the blackbox and the housing, wherein the link is made of perfectly elastic material, and the link is configured to allow the blackbox to be fully attached physically to the housing shortly after the plane crash when the blackbox sinks into a sea bottom, the GPS receiver embedded in the housing failing to locate any GPS signals from the GPS System under the sea.

2. The system of claim 1, wherein the physical communication link is configured to allow the housing to be detached physically from the blackbox after a period of time after sinking into the sea bottom when the blackbox survives the plane crash, the housing, due to its buoyancy, floating onto the water, and the physical ink serving as the only physical media linking between the housing floating onto the water and the blackbox onto the sea bottom.

3. The system of claim 2, wherein the physical communication link is configured to transfer information from the GPS receiver embedded in the housing to the processing unit included in the blackbox, wherein the information includes a location captured by the GPS receiver embedded in the housing when the housing buoys onto the water.

4. The system of claim 3, wherein the physical communication link is configured to transfer information from the processing unit included in the blackbox to the housing, wherein the information transferred includes a combination of the location captured by the GPS receiver and the information in connection with the plane crash included in the blackbox, and wherein the transferred information received by the housing uses the transmitter to broadcast the combined information as signals by air for rescue.

5. The system of claim 4, wherein the physical communication link is configured to save power, re-attach and collapsing physically the housing and the blackbox after broadcasting the combined information for rescue, the housing re-sinking into the bottom of the sea and reattaching with the housing, and the GPS receiver embedded in the housing failing to locate any GPS signals from the GPS System under the sea.

6. The system of claim 5, wherein the physical communication link is configured to, after a pre-determined period expires, allow the GPS receiver embedded in the housing to buoy onto the water to locate another position, after the blackbox has moved to a new position below the sea.

7. The system of claim 6, wherein the physical communication link is configured to allow the transmitter to broadcast the new position and the information in connection with the plane crash included in the blackbox as combined information.
